(19) United States
(12) Patent Application Publication
(10) Pub. No.: US 2014/0333736 A1
(43) Pub. Date: Nov. 13, 2014

(54) IMAGE DISPLAY METHOD AND ASSOCIATED APPARATUS

(71) Applicant: MStar Semiconductor, Inc., Hsinchu Hsien (TW)

(72) Inventors: Kuo-Hsiang Hung, Hsinchu Hsien (TW); Pei-Hung Chiu, Hsinchu Hsien (TW)

(73) Assignee: MStar Semiconductor, Inc., Hsinchu Hsien (TW)

(21) Appl. No.: 14/178,412

(22) Filed: Feb. 12, 2014

(30) Foreign Application Priority Data
May 9, 2013 (TW) 102116577

(51) Int. Cl. H04N 13/04

(52) U.S. Cl. CPC H04N 13/0425
USPC 348/54

(57) ABSTRACT

An image display method includes: receiving an original frame having an original image data part; adjusting the original frame to generate an adjusted frame having an adjusted image data part and a non-image data part, wherein, the adjusted image data part comprises a plurality of pixel lines; and scanning image data of N number of the pixel lines of the adjusted image data part to generate data of N+K number of pixel lines of a scanned frame. N and K are positive integers. The original frame has a same size as that of the adjusted frame; and the adjusted image data part has a size smaller than that of the original image data part.

This application claims the benefit of Taiwan application Serial No. 102116577, filed May 9, 2013, the subject matter of which is incorporated herein by reference.

### BACKGROUND OF THE INVENTION

1. Field of the Invention

The invention relates in general to an image display method and associated apparatus, and more particularly to an image display method and associated apparatus capable of reducing a frame scan time by each time scanning a plurality of pixels lines.

2. Description of the Related Art

FIG. 1 shows a schematic diagram of generating a three-dimensional (3D) image in the prior art. As shown in FIG. 1, a storage device 100 stores combined frames S₁, S₂ and S₃ (only three are depicted as an example). The combined frames S₁, S₂ and S₃ may be from any data source (e.g., another storage device), and respectively include left-eye frame information and right-eye frame information (denoted as L_{f1}, L_{f2}, R_{f1}, R_{f2} . . . ). After accessing the combined frames S₁, S₂ and S₃ from the storage device 100, original left-eye frames and original right-eye frames (only L_{S1}, R_{S1} and L_{S2} are depicted) are sequentially generated according to the left-eye frame information and the right-eye frame information.

More specifically, image data of the original left-eye frame L_{S1} includes image data of the left-eye frame information L_{f1} of the combined frame S₁, and the size of the original left-eye frame L_{S1} is consistent with that of the combined frame S₁ (e.g., both are matrices of 1920×1080 pixels). Image data of the original right-eye frame R_{S1} following the original left-eye frame L_{S1} includes image data of the original right-eye frame information R₁₁ of the combined frame S₁, and the size of the original right-eye frame R_{S1} is consistent with that of the combined frame S₁. Further, image data of the original left-eye frame L_{S2} following the original right-eye frame R_{S1} includes image data of the original left-eye frame L_{f2} of the combined frame S₂, and the size of the original left-eye frame L_{S2} is consistent with that of the combined frame S₂. The subsequent original left-eye and right-eye frames follow the above patterns. A 3D image is then generated according to the original left-eye and right-eye frames. Details for generating a 3D image by utilizing left-eye and right-eye frames and glasses are known to a person having ordinary skill in the art, and shall be omitted herein.

FIG. 2 shows a reason causing cross-talk in a liquid crystal display (LCD) apparatus. A frame is scanned from a first pixel line L1, and a liquid crystal stable state is reached. The frame is continually scanned from a second pixel line L2, and a liquid crystal stable state is reached. The time at which the last scan line Lₙ reaches a liquid crystal stable state is T₁, which is the time for generating and getting the frame ready for display. If the time T₁ is too long that it overlaps with a time interval of previous frame, cross-talk at a monitor appears.

### SUMMARY OF THE INVENTION

The invention is directed to a method and associated apparatus for generating a three-dimensional (3D) image to improve cross-talk when generating the 3D image.

According to an embodiment of the present invention, an image display method is provided. The image display method includes: a) receiving an original frame having an original image data part; b) adjusting the original frame to generate an adjusted frame having an adjusted image data part and a non-image data part, wherein, the adjusted image data part comprises a plurality of pixel lines; and c) scanning image data of N number of the pixel lines of the adjusted image data part to generate data of N+K number of pixel lines of a scanned frame. N and K are positive integers. The original frame has a same size as that of the adjusted frame; and the adjusted image data part has a size smaller than that of the original image data part.

According to another embodiment of the present invention, an image display apparatus is provided. The image display apparatus includes an adjustment device and an image scanning device. The adjustment device receives an original frame having an original image data part, and adjusts the original frame to generate an adjusted frame having an adjusted image data part and a non-image data part, wherein, the adjusted image data part comprises a plurality of pixel lines. The image scanning device scans image data of N number of the pixel lines of the adjusted image data part to generate data of N+K number of pixel lines of a scanned frame, wherein N and K are positive integers. The original frame has a same size as that of the adjusted frame; and the adjusted image data part has a size smaller than that of the original image data part.

With the foregoing embodiments, by scanning a plurality of pixel lines in each scan, the time for scanning the frames can be reduced to improve cross-talk.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of generating a 3D image in the prior art;

FIG. 2 is a schematic diagram of cross-talk in the prior art;

FIG. 3 is a schematic diagram of operations for adjusting left-eye and right-eye frames according to an embodiment of the present invention;

FIG. 4 is a schematic diagram of operations for generating a 3D image according to an embodiment of the present invention;

FIG. 5 is a block diagram of an image display apparatus according to an embodiment of the present invention;

FIG. 6 is a block diagram of an image display apparatus according to another embodiment of the present invention; and

FIG. 7 is a schematic diagram of utilizing an image display mechanism of the present invention to improve cross-talk.

### DETAILED DESCRIPTION OF THE INVENTION

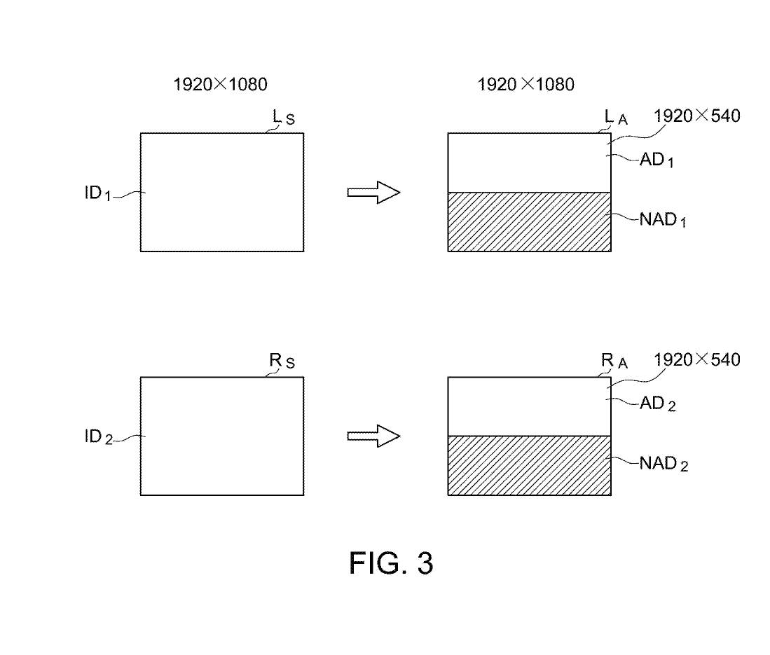

FIG. 3 shows a schematic diagram of operations for adjusting left-eye and right-eye frames according to an embodiment of the present invention. In the description below, a data part refers to a part of image data that is needed for establishing a 3D image. As shown in FIG. 3, an original left-eye frame L_{S} and an original right-eye frame R_{S} are received. The original left-eye frame L_{S} includes a first original image data part ID₁, and the original right-eye frame R_{S} includes a second original image data part ID₂. In the embodiment, information included in the original left-eye frame L_{S} is the first original image data part ID₁, and information included in the original right-eye frame R_{S} is the second original image data part ID₂. The first original image data part ID₁ and the second original image data part ID₂ may also include only a part of the original left-eye frame L_{S} and a part of the original right-eye frame R_{S}, respectively.

The original left-eye frame L_{S} and the original right-eye frame R_{S} are adjusted to generate an adjusted left-eye frame L_{A} and an adjusted right-eye frame R_{A}, respectively. The original left-eye frame L_{S} has a same size as that of the adjusted left-eye frame L_{A}, and the original right-eye frame R_{S} has a same size as that of the adjusted right-eye frame R_{A} (for example, matrices of 1920×1080 pixels). The adjusted left-eye frame L_{A} includes a first adjusted image data part AD₁ and a first non-image data part NAD₁, and the adjusted right-eye frame R_{A} includes a second adjusted image data part AD₂ and a second non-image data part NAD₂. The first adjusted image data part AD₁ has a size smaller than that of the first original image data part ID₁, and the second adjusted image data part AD₂ has a size smaller than that of the second original image data part ID₂.

In one embodiment, the first non-image data part NAD₁ and the second non-image data part NAD₂ are black images, and are rear half regions of the adjusted left-eye frame L_{A} and the adjusted right-eye frame R_{A}, respectively. That is, the original left-eye frame L_{S}, the original right-eye frame R_{S}, the adjusted left-eye frame L_{A} and the adjusted right-eye frame R_{A} are all matrices in 1920×1080 pixels; whereas, the first adjusted image data part AD₁, the first non-image data part NAD₁, the second adjusted image data part AD₂ and the second non-image data part NAD₂ are all matrices in 1920×540 pixels, and do not overlap one another. Thus, in one embodiment, the original left-eye frame L_{S} is reduced into the first adjusted image data part AD₁, and the original right-eye frame R_{S} is reduced into the second adjusted image data part AD₂. The first non-image data part NAD₁ and the second non-image data part NAD₂ are then inserted. However, the adjustment is not limited to the above method. By inserting the non-image data parts, the frames can be maintained in the original sizes so that a method for data transmission need not be changed, thereby offering a simpler design process.

It should be noted that, the sizes and locations as well as information types of the non-image data parts of the adjusted left-eye and right-eye frames are not limited to the examples given in the foregoing embodiment. For example, the non-image data parts may occupy only one-third of the adjusted left-eye and right-eye frames, with the one-third locating at a front end instead of a rear end. Further, in addition to black images, the information type of the non-image data parts may also be grayscale images or no data.

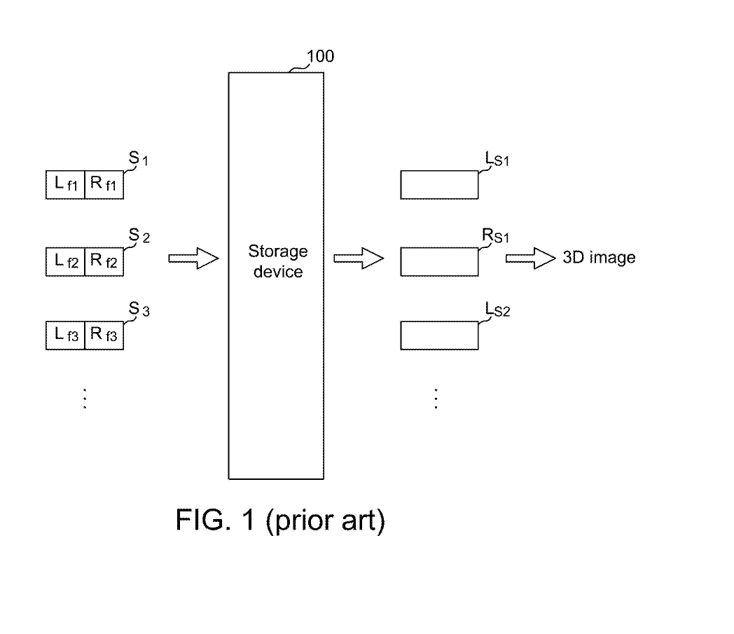

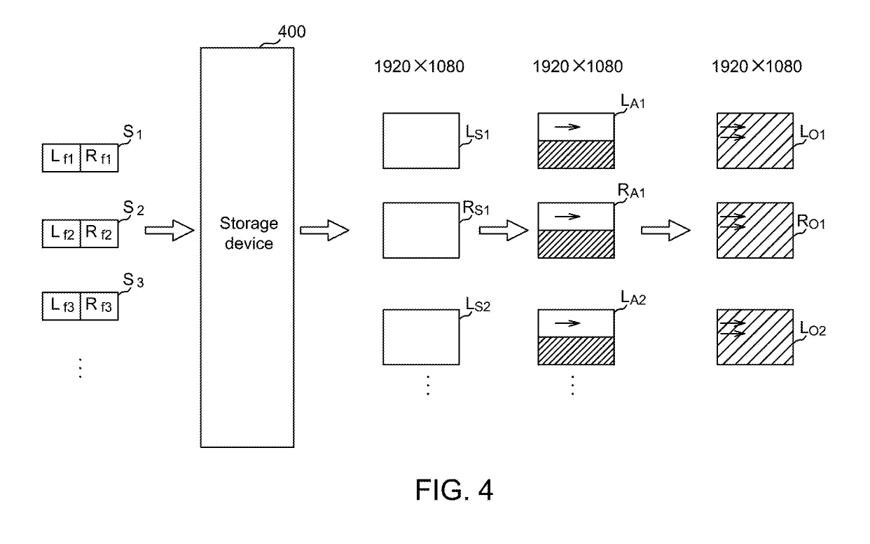

FIG. 4 shows a schematic diagram of operations for generating a 3D image according to an embodiment of the present invention. It should be noted that the number of frames in the diagram is an example for describing the present invention, not limiting the present invention. As shown in FIG. 4, a storage device 400 receives the combined frames S₁, S₂, S₃ . . . as those in FIG. 1, and the combined frames S₁, S₂, S₃ similarly include left-eye frame information L_{f1}, L_{f2}, and L_{f3} and right-eye frame information R_{f1}, R_{f2}, and R_{f3}. Original left-eye frames L_{S1}, L_{S2} and L_{S3} and an original right-eye frame R_{S1}, R_{S2}, and R_{S3} are generated according to the left-eye frame information L_{f1}, L_{f2} and L_{f3} and right-eye frame information R_{f1}, R_{f2} and R_{f3}. The original left-eye frames L_{S1}, L_{S2} and L_{S3} and the original right-eye frame R_{S1}, R_{S2}, and R_{S3} may be generated and stored into the storage device 400, or may be generated after accessing the left-eye frame information and the right-eye frame information from the storage device 400. Alternatively, the original left-eye frames L_{S1}, L_{S2} and L_{S3} and the original right-eye frame R_{S1}, R_{S2}, and R_{S3} may be directly generated without involving the storage device 400. The original left-eye frames L_{S1}, L_{S2} and L_{S3} and the original right-eye frame R_{S1}, R_{S2}, and R_{S3} are then adjusted into adjusted left-eye frames L_{A1}, L_{A2} and L_{A3}, and adjusted right-eye frames R_{A1}, R_{A2} and R_{A3}, as shown in FIG. 4. The adjusted left-eye frame L_{A1}, the adjusted right-eye frame R_{A1}, the adjusted left-eye frame L_{A2}, etc. are scanned to generate 3D images. When scanning the adjusted left-eye and right-eye frames, two pixel lines of the frames are scanned each time, as shown in FIG. 4. As such, the scanning speed for the frames can be increased. In one embodiment, after scanning the pixel lines of the adjusted right-eye frame R_{A1} and the adjusted left-eye frame L_{A1}, image data obtained from the scanning is scaled to obtain a scanned left-eye frame L_{O1} and a scanned right-eye frame R_{O1}. For example, one pixel line in the adjusted right-eye frame R_{A1} is scanned, and is scaled up to form image data of two pixel lines of the scanned right-eye frame R_{O1}. In one embodiment, the scanned left-eye frame L_{O1} has a same size as that of the adjusted left-eye frame L_{A1}, and the scanned right-eye frame R_{O1} has a same size as that of the adjusted right-eye frame R_{A1}, for example.

It should be noted that, instead of being generated from the combined frames S₁, S₂ and S₃ in FIG. 4, the original left-eye frames or the original right-eye frames may also be generated by other methods. Further, the 3D image is not limited to being generated from the left-eye and right-eye frames; that is, the foregoing embodiment may be applied to two different types of frames that are not left-eye and right-eye frames. Further, the present invention is not limited to a 3D image display method, and an image display method based on two types of frames is encompassed within the scope of the present invention. Therefore, the image display method according to an embodiment of the present invention may be simplified as follows: receiving an original first-type frame (e.g., L_{S} in FIG. 3) and an original second-type frame (e.g., R_{S} in FIG. 3), wherein the original first-type frame includes a first original image data part and the original second-type frame includes a second original image data part; adjusting the original first-type frame and the original second-type frame to generate an adjusted first-type frame (e.g., L_{A} in FIG. 3) and an adjusted second-type frame (e.g., R_{A} in FIG. 3), respectively, wherein the first adjusted image data part and the second adjusted image data part include a plurality of pixel lines; each time when scanning the adjusted first-type image data part or the adjusted second-type image data part, scanning image data of N number of pixel lines of the first adjusted image data part or the second adjusted image data part to generate data of N+K number of pixel lines of the scanned first-type frame (e.g., L_{O1}) or the scanned second-type frame (e.g., R_{O1}), and displaying the scanned first-type frame or the scanned second-type frame, where N and K are positive integers. In the embodiment in FIG. 4, N and K are both 1, for example. Details of the original first-type frame, the original second-type frame, the adjusted first-type frame and the adjusted second-type frame are given in the description associated with FIG. 3, and shall be omitted herein.

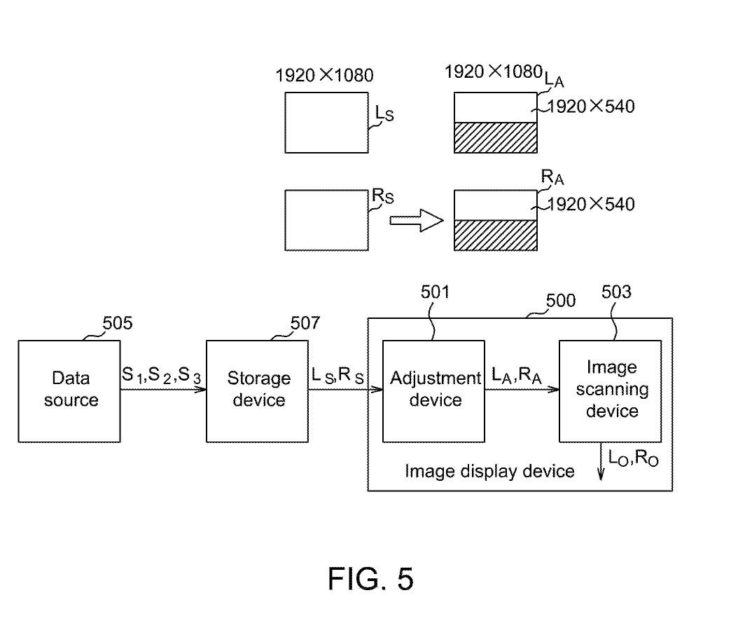

FIG. 5 shows a block diagram of an image display apparatus 500 according to an embodiment of the present invention. As shown in FIG. 5, the image display apparatus 500 includes an adjustment device 501 and an image scanning device 503. The adjustment device 501 receives original left-eye and right-eye frames L_{S} and R_{S}, and adjusts the original left-eye and right-eye frames L_{S} and R_{S} to generate adjusted left-eye and right-eye frames L_{A} and R_{A}, respectively. In one embodiment, the adjustment device 501 is a scaler, which down-scales the original left-eye and right-eye frames L_{S} and R_{S} to generated data parts of the adjusted left-eye and right-eye frames L_{A} and R_{A}, and then inserts non-image data parts of the adjusted left-eye and right-eye frames L_{A} and R_{A}. Each time when scanning the adjusted left-eye and right-eye frames L_{A} and R_{A}, the image scanning device 503 scans image data of N number of pixel lines of the adjusted left-eye and right-eye frames L_{A} and R_{A} to generate data of N+K pixel lines of the scanned left-eye and right-eye frames L_{O} and R_{O}, respectively, where N and K are positive integers. The image display apparatus 500 then displays at least one of the scanned left-eye and right-eye frames L_{O} and R_{O}.

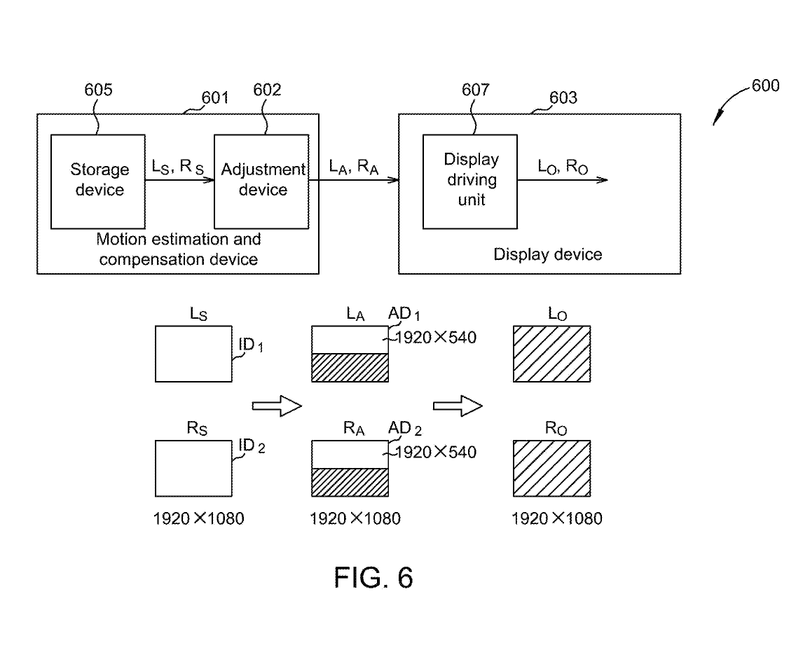

FIG. 6 shows a block diagram of an image display apparatus 600 according to another embodiment of the present invention. In the embodiment in FIG. 6, the image display apparatus 600 includes a motion estimation and compensation device 601 and a display device 603. The adjustment device and storage device in FIG. 5 are located in the motion estimation and compensation device 601, and the image scanning device is integrated into a display driving unit 607 located in the display device 603. Thus, the original left-eye and right-eye frames L_{S} and R_{S} stored in the storage device 605 are motion compensated frames. The adjusted left-eye and right-eye frames L_{A} and R_{A} are inputted into the display driving unit 607 and scanned to generate the scanned left-eye and right-eye frames L_{O} and R_{O}. As previously stated, the left-eye and right-frames may be replaced by other types of first-type and second-type frames.

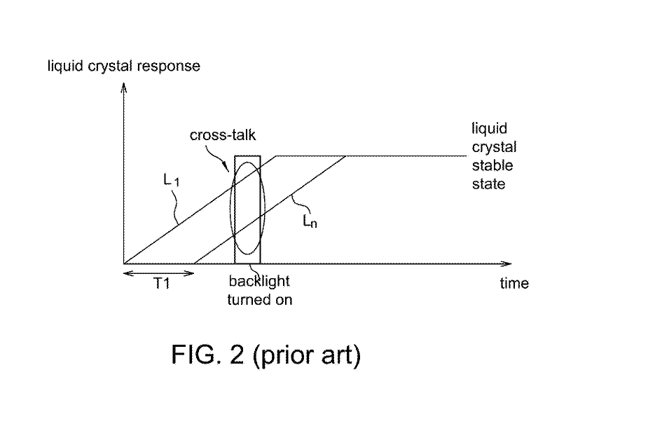

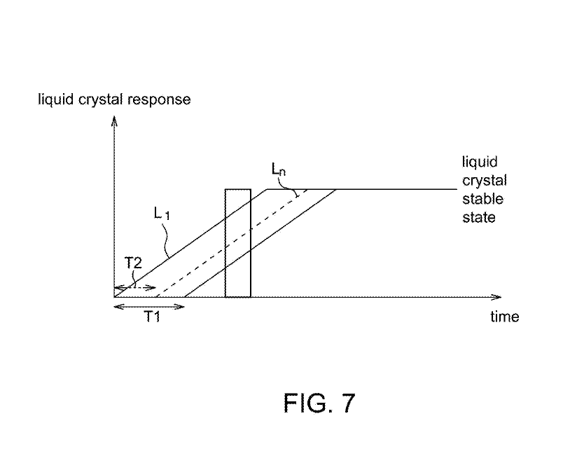

FIG. 7 shows a schematic diagram of utilizing an image display mechanism of the present invention to improve cross-talk. As shown in FIG. 7, since only a scaled down frame (1920×1080 to 1920×540) needs to be scanned, the time required for scanning the first pixel line L₁ to the last pixel line Lₙ is T₂, which is shorter than the time T₁ in FIG. 2. Therefore, the possibility of overlapping between the frames is reduced to thus improve cross-talk.

It is demonstrated with the foregoing embodiments that, by scanning a plurality of pixel lines in each scan, the time for scanning frames can be reduced to thus improve cross-talk.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image display method, comprising:
receiving an original frame having an original image data part;
adjusting the original frame to generate an adjusted frame having an adjusted image data part and a non-image data part, wherein, the adjusted image data part comprises a plurality of pixel lines; and
scanning image data of N number of the pixel lines of the adjusted image data part to generate data of N+K number of pixel lines of a scanned frame, wherein N and K are positive integers;
wherein, the original frame has a same size as that of the adjusted frame; and the adjusted image data part has a size smaller than that of the original image data part.

2. The image display method according to claim 1, wherein the adjusted image data part and the adjusted non-image data part occupy one-half of the adjusted frame, respectively.

3. The image display method according to claim 2, wherein the adjusted image data part is a front half of the adjusted.

4. The image display method according to claim 1, wherein the non-image data part comprises at least one of information types of a black image, a grayscale image and no data.

5. The image display method according to claim 1, wherein the step of adjusting the original frame to generate the adjusted frame comprises:
down-scaling the original image data part as the adjusted image data part.

6. The image display method according to claim 1, wherein the original frame has a same size as that of the scanned frame.

7. An image display apparatus, comprising:
an adjustment device, configured to receive an original frame having an original image data part, and to adjust the original frame to generate an adjusted frame having an adjusted image data part and a non-image data part, wherein, the adjusted image data part comprises a plurality of pixel lines; and
an image scanning device, configured to scan image data of N number of the pixel lines of the adjusted image data part to generate data of N+K number of pixel lines of a scanned frame, wherein N and K are positive integers;
wherein, the original frame has a same size as that of the adjusted frame, and the adjusted image data part has a size smaller than that of the original image data part.

8. The image display apparatus according to claim 7, wherein the adjusted image data part and the non-image data part occupy one-half of the adjusted frame, respectively.

9. The image display apparatus according to claim 8, wherein the adjusted image data part is a front half of the adjusted frame.

10. The image display apparatus according to claim 8, wherein the non-image data part comprises at least one of information types of a black image, a grayscale image and no data.

11. The image display apparatus according to claim 7, wherein the adjustment device is a scaler, and the scaler down-scales the original image data part as the adjusted image data part.

12. The image display apparatus according to claim 7, wherein the original frame has a same size as that of the scanned frame.

13. The image display apparatus according to claim 7, wherein the adjustment device is integrated in a motion estimation and compensation device.

14. The image display apparatus according to claim 7, wherein image scanning device is integrated in a display driving unit of a display.
